(19) United States
(12) Patent Application Publication
(10) Pub. No.: US 2024/0326309 A1
(43) Pub. Date: Oct. 3, 2024

(54) EXTERIOR COMPOSITE BOARD

(71) Applicant: FIBER COMPOSITES, LLC, New London, NC (US)

(72) Inventors: Petros Demetrios Kotiadis, Youngstown, NY (US); Lawrence Edward Gates, Wilmington, NC (US); Andres Dabdoub Paz, Charlotte, NC (US)

(21) Appl. No.: 18/442,778

(22) Filed: Feb. 15, 2024

Related U.S. Application Data
(60) Provisional application No. 63/485,423, filed on Feb. 16, 2023.

(51) Int. Cl. B29C 48/00; B29C 48/07; B29K 21/00; B29K 23/00; B29K 67/00; B29K 105/16; B29L 7/00; E04F 15/02; E04F 15/10

(52) U.S. Cl. CPC B29C 48/0023; B29C 48/002; B29C 48/07; E04F 15/02183; E04F 15/107; B29K 2021/003; B29K 2023/06; B29K 2023/12; B29K 2067/003; B29K 2105/16; B29L 2007/002

(57) ABSTRACT

The present disclosure is directed to an exterior composite board comprising a core formed from polymeric material and a filler. The core may be an elongated member or other relevant shape for a construction material. An opaque tie layer is disposed on at least one surface of the core. An optional primer and/or optional textured layer may be disposed on the tie layer. The optional textured layer has surface features defined by varying depth. The optional primer layer and/or optional textured layer are digitally printed on the previous layer. Next, a color layer is disposed on the optional primer layer or optional textured layer, or if no optional primer or optional textured layer is present, directly on the tie layer. The color layer, which may comprise up to four different individually applied layers, is digitally printed on the optional primer layer, optional textured layer, or tie layer. The outermost layer disposed on the color layer is the protective layer.

### CROSS-REFERENCE TO RELATED APPLICATIONS

This application claims the benefit of U.S. Provisional Patent Application No. 63/485,423, titled “EXTERIOR COMPOSITE BOARD,” filed on Feb. 16, 2023, the entire disclosure of which is incorporated herein by reference.

### FIELD

The present disclosure relates to building materials. More particularly, the present disclosure relates to an exterior polymer-based composite board having digitally printed color and optionally digitally printed texture, as well as methods for making the same.

### BACKGROUND

Decks, docks, and other platform-like structures with decking surface typically are constructed from wood, particularly in North America. Many times, wood will split, warp, twist, splinter and/or rot due to exposure to the environment, and particularly from exposure to moisture, heat, cold, and UV. These issues become even more problematic on decking surfaces which may face more exposure as a horizontal surface, as opposed to a vertical surface which can be shielded from sun, wind, water, etc.

To address the issues with wood decking, several manufacturers now offer decking materials constructed from composite materials, which can include polymeric resins and often some form of filler. These decking materials typically are formed as elongated boards. The boards are constructed by extruding composite materials through a high-pressure extruder. The resultant composite boards are more resistant to warping, splitting, twisting, splintering, and rotting than conventional wood boards.

### SUMMARY

Disclosed herein are exterior polymer-based composite boards having digitally printed color and optionally digitally printed texture, and methods for manufacturing these exterior polymer-based composite boards having digitally printed color and optionally texture.

An exterior composite board comprising a core, an opaque tie layer, at least one of: a primer layer and a textured layer, a color layer, and a protective layer is disclosed herein. The core comprises a polymeric resin comprising a polyethylene (PE), polypropylene (PP), a polyethylene terephthalate (PET), a thermoplastic elastomer (TPE), or combinations thereof; and a filler comprising an organic filler, a mineral filler, or combinations thereof. The core has a top surface, a bottom surface opposing the top surface, a left side surface, and a right side surface opposing the left side surface, the left and right side surfaces each extend between the top surface and the bottom surface. The opaque tie layer is disposed on at least one surface of the core, wherein the opaque tie layer comprises a cured polymeric resin. At least one of the primer layer and the textured layer is disposed on the tie layer, or if both are present, the textured layer is disposed on the primer layer. Each of the primer layer and the textured layer when present comprise a cured polymeric resin, where the textured layer when present has surface features defined by a varying depth. The color layer is disposed on the primer layer or textured layer, where the color layer comprises a cured polymeric resin and an inorganic ink. The protective layer is disposed on the color layer. The protective layer may provide a resistance to at least one of weathering and abrasion. In the exterior composite board, the adhesive value between the tie layer and at least one surface of the core upon which the tie layer is disposed has less than about 5% of material removed according to the Cross-Cut Tie Layer Tape Test disclosed herein.

A method for manufacturing an exterior composite board is also disclosed herein. The method includes extruding a core comprising a polymeric resin and a filler as disclosed herein; etching at least one surface of the core to form at least one etched surface; applying a tie layer coating composition to the at least one etched surface and curing the tie layer coating composition to form a cured opaque tie layer on the at least one etched surface, wherein the step of etching modifies the at least one surface of the core so as to improve adhesion to the cured opaque tie layer; digitally printing at least one of: (a) a primer layer polymeric resin on the tie layer, and (b) a textured layer polymeric resin on the tie layer, or if a primer layer is present, on the primer layer, and curing the primer layer polymeric resin and/or textured layer polymeric resin, wherein the textured layer when present has surface features defined by a varying depth; digitally printing up to four independent color layers comprising a color layer polymeric resin and inorganic ink on the primer or textured layer and at least partially curing each printed color layer before printing the next color layer, the up to four color layers are selected from a cyan color layer, a magenta color layer, a yellow color layer, and a black color layer; fully curing the up to four color layers; and applying a protective layer polymeric resin to the up to four color layers and curing the protective layer polymeric resin to form the protective layer. The cured protective layer may provide resistance to weathering and abrasion.

In another aspect, an exterior composite board comprising a core, an opaque tie layer, a color layer, and a protective layer is disclosed herein. The core comprises a polymeric resin comprising a polyethylene (PE), polypropylene (PP), a polyethylene terephthalate (PET), a thermoplastic elastomer (TPE), or combinations thereof; and a filler comprising an organic filler, a mineral filler, or combinations thereof. The core has a top surface, a bottom surface opposing the top surface, a left side surface, and a right side surface opposing the left side surface, the left and right side surfaces each extend between the top surface and the bottom surface. The opaque tie layer is disposed on at least one surface of the core, wherein the opaque tie layer comprises a cured polymeric resin. The color layer is disposed on the tie layer, where the color layer comprises a cured polymeric resin and an inorganic ink. The protective layer is disposed on the color layer. The protective layer may provide a resistance to at least one of weathering and abrasion. In the exterior composite board, the adhesive value between the tie layer and at least one surface of the core upon which the tie layer is disposed has less than about 5% of material removed according to the Cross-Cut Tie Layer Tape Test disclosed herein.

In another aspect, a method for manufacturing an exterior composite board is also disclosed herein. The method includes extruding a core comprising a polymeric resin and a filler as disclosed herein; etching at least one surface of the core to form at least one etched surface; applying a tie layer coating composition to the at least one etched surface and curing the tie layer coating composition to form a cured opaque tie layer on the at least one etched surface, wherein the step of etching modifies the at least one surface of the core so as to improve adhesion to the cured opaque tie layer; digitally printing up to four independent color layers comprising a color layer polymeric resin and inorganic ink on the tie layer and at least partially curing each printed color layer before printing the next color layer, the up to four color layers are selected from a cyan color layer, a magenta color layer, a yellow color layer, and a black color layer; fully curing the up to four color layers; and applying a protective layer polymeric resin to the up to four color layers and curing the protective layer polymeric resin to form the protective layer. The cured protective layer may provide resistance to weathering and abrasion.

Other aspects of the present disclosure will be apparent from the description that follows.

### BRIEF DESCRIPTION OF THE DRAWINGS

The following is a brief description of the figures. The figures herein are not to scale. For example, the size of the layers shown in the figures are not proportional to the size of the substrate and are merely for illustrative purposes.

FIG. 1 shows a perspective view of an exemplary exterior composite board having three surfaces of the core with the different layers in accordance with the present disclosure.

FIG. 2A shows a cross-sectional profile view of the exemplary exterior composite board having layers in accordance with the present disclosure on one surface of the core with an optional textured layer but without an optional primer layer.

FIG. 2B shows cross-sectional profile view of the exemplary exterior composite board having layers in accordance with the present disclosure on one surface of the core with both an optional primer layer and an optional textured layer.

FIG. 2C shows cross-sectional profile view of the exemplary exterior composite board having layers in accordance with the present disclosure on one surface of the core with an optional primer layer but without an optional textured layer.

FIG. 2D shows cross-sectional profile view of the exemplary exterior composite board having layers in accordance with the present disclosure on one surface of the core but without an optional primer layer and without an optional textured layer.

FIGS. 3A, 3B, and 3C are flow charts of exemplary methods of manufacturing the exterior composite boards according to the present disclosure.

### DETAILED DESCRIPTION

Unless otherwise indicated herein, “surface modification” includes any treatment to a surface that changes the surface energy of that surface, and includes any of the forms of etching disclosed herein.

Unless otherwise indicated herein, the term “thermoplastic” refers to that generally understood in the art: plastic material, typically a polymer, that becomes pliable or moldable above a specific temperature and solidifies upon cooling. Typically, thermoplastic materials are reusable or recyclable. This is in contrast to a thermoset, which as used herein, refers to a plastic material, typically a polymer, that irreversibly cures (i.e., crosslinks) and thus cannot be reshaped or remolded following cure.

As discussed above, the present disclosure is directed to an exterior composite board having a core comprising a polymeric resin and a filler. The core is formed by mixing the polymeric resin and filler together and extruding them into a board-like shape or other relevant shape for a construction material. Although such boards may provide benefits over comparable wood boards, e.g., resistance to warping, splitting, twisting, and rotting, they also have challenges or limitations relative to the wood boards. Many end users would like the polymer-based composite boards to resemble conventional construction materials like wood, concrete, masonry, etc. but obtaining realistic texture or color or both on these polymer composites is difficult. This difficulty may be due to the polymer used for the boards. For example, if the polymeric resins used for the boards are recycled plastics, e.g., recycled polyethylene, it may be more difficult to get a realistic, let alone uniform color or realistic texture on the extruded board.

The exterior composite boards of the present disclosure disclose digitally printing texture of varying topographies, digitally printing color to provide a more realistic color and feel, or both digitally printing texture of varying topographies and digitally printing color. However, it is not always possible to consistently digitally print on the polymeric resins of the present disclosure, e.g., recycled polyethylene, because of the lack of uniformity of color coming from the recycled material, thus providing an inconsistent background color on which to print. And due to the nature of the polymeric resin itself, for example, polyolefins like polyethylene are often thought of as having an oily and waxy feel and good chemical resistance, it is difficult to adhere to, let alone digitally print on. The composite boards of the present disclosure apply some form of surface modification such as etching to the composite board's core, and then apply a tie layer coating over the surface modified core. This surface modification allows the tie layer of the present disclosure to suitably adhere to the core and provides a unified, opaque substrate onto which the texture and/or color can be printed. After the tie layer is adhered in accordance with the present disclosure, the adhesive value between the tie layer and at least one surface of the core upon which the tie layer is disposed has less than about 5% of material removed according to the Cross-Cut Tie Layer Tape Test disclosed herein, including no material removed. In other words, the adhesion of the tie layer to the core exhibits less than about 5% flaking or adhesive failure or no flaking or adhesive failure in the cross-cut area tested under the Cross-Cut Tie Layer Tape Test. For the whole (complete) exterior board with all layers of the present disclosure, the adhesive value between the protective layer and all other layers in-between disposed on the core has less than about 5% of material removed for the Cross-Cut Protective Layer Tape Test disclosed herein, including no material removed. In other words, the adhesion of the protective layer should exhibit less than about 5% flaking or adhesive failure or no flaking or adhesive failure in the cross-cut area tested on the exterior composite board under the Cross-Cut Protective Layer Tape Test.

Another problem that the exterior boards of the present disclosure face is the harsh conditions outside, particularly weathering or fading due to UV exposure. As discussed above, the desired coloring for the boards is provided through digital printing. However, conventional organic pigments used in the digital inks are not durable for the outdoors, and particularly UV exposure, and will fade over time. The exterior boards according to certain aspects of the present disclosure apply a color layer containing inorganic pigments and are much more durable to UV exposure and fading. For example, exterior composite boards in accordance with the present disclosure retain color at a value of less than 5 units of Delta E over 5,000 hours, including in certain aspect over 10,000 hours, of exposure as measured in accordance with the QUV Weathering Test of the present disclosure. In other words, the value of CIELAB E of the exterior composite board changes less than 5 units when tested over 5,000 hours, and in certain aspects over 10,000 hours, under the QUV Weathering Test of the present disclosure.

### Exterior Composite Board

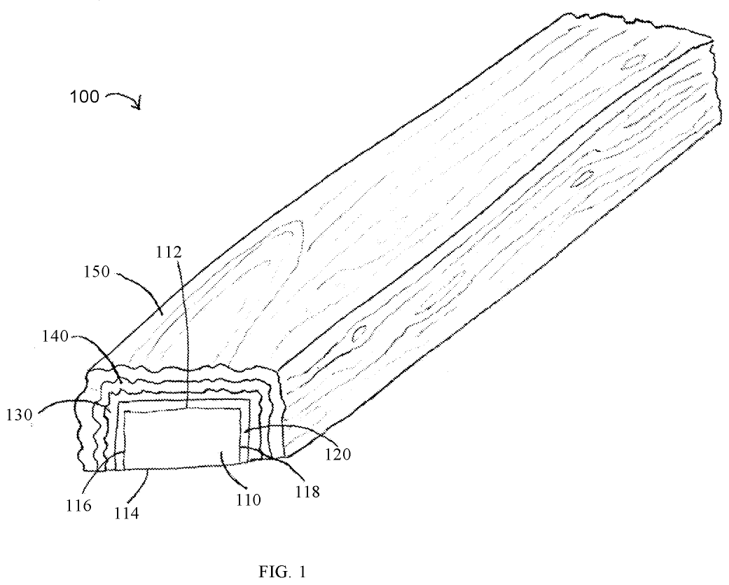

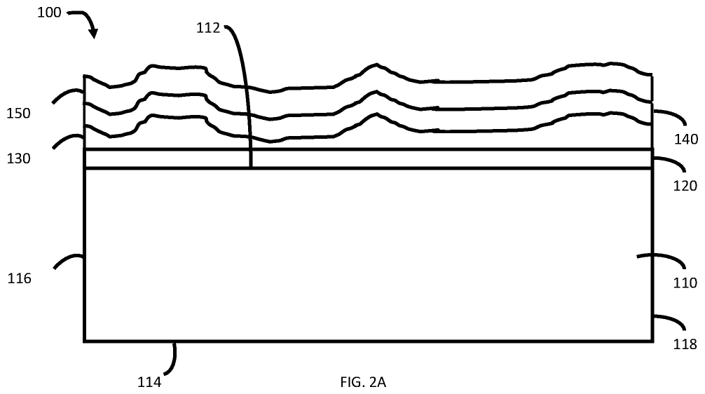

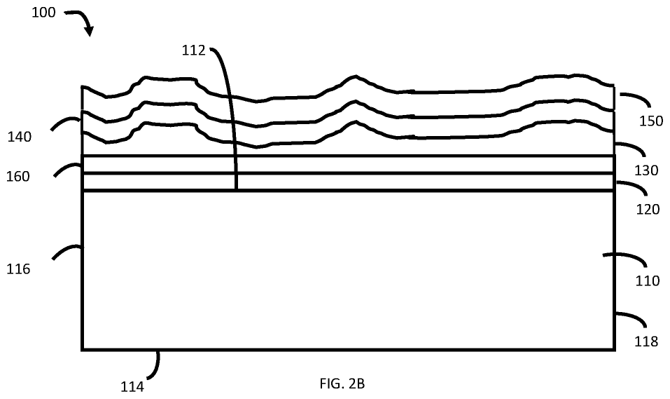

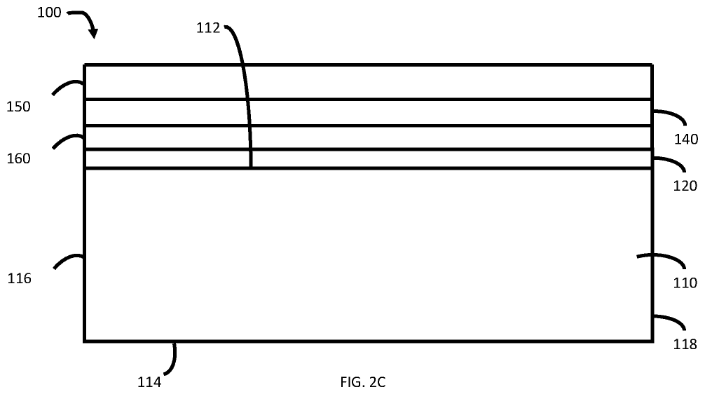

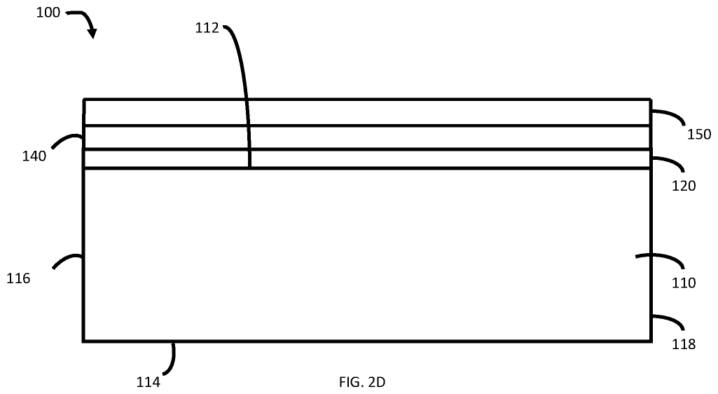

FIGS. 1, 2A, 2B, 2C, and 2D illustrate exemplary exterior composite boards 100 of the present disclosure. The exterior composite board 100 comprises a core 110 comprising a polymeric resin and a filler. The core 110 may be an elongated member or other shape relevant for a construction material having a top surface 112, a bottom surface 114 opposing the top surface 112, a left side surface 116, and a right side surface 118 opposing the left side surface 116, the left 116 and right 118 side surfaces each extend between the top surface 112 and the bottom surface 114. An opaque tie layer 120 is disposed on at least one surface (112, 114, 116, 118) of the core 110, the opaque tie layer 120 comprising a cured polymeric resin.

An optional primer layer 160 or optional textured layer 130 is disposed on the tie layer 120, each of the optional primer layer 160 (FIGS. 2B, 2C) and the optional textured layer 130 (FIGS. 1, 2A, 2B) comprising a cured polymeric resin. As shown in FIG. 2B, the optional textured layer 130 may be disposed on the optional primer layer 160 or alternatively as shown in FIGS. 1 and 2A, directly on the tie layer 120. As shown in FIGS. 2A and 2B, the optional textured layer 130 has surface features defined by varying measurable depth. Next, a color layer 140 is disposed on the optional primer layer 160 (FIG. 2C) or the optional textured layer 130 (FIGS. 1, 2A, 2B). Alternatively, the color layer 140 is disposed on the opaque tie layer 120 (FIG. 2D). The color layer 140 comprises a cured polymeric resin and an inorganic ink. The outermost layer is the protective layer 150 disposed on the color layer 140. The protective layer preferably provides resistance to weathering and/or abrasion. The optional primer layer 160 improves adhesion between the tie layer 120 and the next layer, e.g., the optional textured layer 130 or the color layer 140. The strength of the adhesion between the cured tie layer 120 and the at least one surface (112, 114, 116, 118) of the core 110 contributes to the durability of the exterior composite board 100 because it may provide a substrate to apply (e.g., print) the optional textured 130 and color 140 layers on and may provide a uniform background color for those layers, which as discussed above assists in providing the realistic optional texture and color to the board.

### Core

The exterior composite board 100 of the present disclosure comprises a core 110. The core 110 is generally extruded as an elongated member or other shape relevant for construction and comprises a polymeric resin and a filler. The core 110 comprises from 20% to 98% by weight polymeric resin based on the total weight of the core 110, including 20% to 85%, including 25% to 70%, including 30% to 50%, and including 35% to 45%. The core 110 comprises from 1% to 80% by weight filler based on the total weight of the core 110, including 2% to 80%, including 10% to 75%, including 15% to 75%, including 25% to 70%, including 35% to 70%, including 40% to 70%, including 50% to 70%, and including 55% to 65%.

Suitable polymeric resins used in the core 110 include polyethylene (PE), polypropylene (PP), a polyethylene terephthalate (PET), a thermoplastic elastomer (TPE), and/or combinations thereof. These exemplary resins are thermoplastic resins, which means that they are resins that can be recycled. As such, the polymer resins used in the core can be neat (pure or substantially pure), or recycled forms of these polymeric resins, such as recycled polyethylene (PE), recycled polypropylene (PP), recycled polyethylene terephthalate (PET), recycled thermoplastic elastomer (TPE), and/or combinations thereof. The core can also include a combination of neat forms (pure or substantially pure) and recycled forms of these polymers. For example, the polymeric resin of the core 110 can include any combination of the following: polyethylene (PE), polypropylene (PP), a polyethylene terephthalate (PET), a thermoplastic elastomer (TPE), recycled polyethylene (PE), recycled polypropylene (PP), recycled polyethylene terephthalate (PET), and recycled thermoplastic elastomer (TPE). In an aspect of the present disclosure, the polymeric resin comprises a minimum of 20% by weight recycled polymeric resin, including 20% to 100%, including 25% to 99%, including 45% to 95%, and including 50-85%. In certain aspects, the polymeric resin comprises a minimum of 20% by weight recycled polyethylene, including 20% to 100%, including 25% to 99%, including 45% to 95%, and including 50-85%.

If the polymeric resin of the core 110 includes polyethylene (recycled or neat), it can further comprise linear low density polyethylene (LLDPE), low density polyethylene (LDPE), medium density polyethylene (MDPE), high density polyethylene (HDPE), ultra-high molecular weight polyethylene (UHMWPE), and combinations thereof.

In addition to the polymeric resin, the core 110 also includes a filler. Suitable fillers, include, but are not limited to, an organic filler, a mineral filler, and/or combinations thereof. Examples of suitable organic fillers include, but are not limited to, cellulosic material, organic polymer fiber such as carbon fiber, biochar, and/or combinations thereof. Cellulosic material includes, but are not limited to, wood or wood byproducts like wood flour, wood fibers, sawdust, wood shavings; paper or newsprint or their byproducts; plant materials such as flax, hemp, wheat straw, rice hulls, soy hulls, kenaf, jute, sisal, seed shells e.g., peanut or walnut shells, other natural fibers; and/or combinations thereof. Cellulosic material should be understood herein to include lignocellulosic material. Examples of suitable mineral fillers include, but are not limited to, any solid inorganic material, preferably inorganic particulates or fibers. Examples of more particular inorganic materials include silicas, silicates, aluminas, aluminates, aluminosilicates, and/or combinations thereof. Examples of more specific and/or sources of such inorganic material include talc, mica, clay, feldspars, diatomaceous earth, fumed silica, amorphous silica, fumed aluminum oxide, sand, wollastonite, calcium carbonate, carbon black, glass fibers, glass beads, and/or combinations thereof.

In addition to the polymeric resin and filler, the core may further include an additive comprising any one or more of antioxidants, light stabilizers, fibers, blowing agents, foaming additives, antiblocking agents, heat stabilizers, impact modifiers, biocides, antimicrobial additives, compatibilizers, plasticizers, tackifiers, colorants, processing aids, lubricants, coupling agents, flame retardants, color streakers, ultraviolet reflective additives, infrared reflective additives, thermally conductive additives, and/or pigments. The core 110 may comprise from 0 to 10% by weight additive based on the total weight of the core 110, including from 0.001% to 7.5%, including from 0.001% to 5%, including 1% to 5%, and including 2-5%.

The core 110 is generally formed via extrusion by heating and mixing (e.g., shear) the different components of the core 110, e.g., the polymer resin, the filler, and any optional additives to form a molten mixture and forcing the molten mixture through an extrusion die, with the extrudate emerging through the die forming the core 110. This can be done using conventional extruders, e.g., one or multiscrew extruders. One of ordinary skill in this field would recognize the appropriate time, temperature, and any other parameters needed under extrusion or other manufacturing processes to form the core 110.

For example, in an exemplary extrusion process used to form the core, a co-rotating twin-screw extruder is used to achieve maximum mixing efficiency; however, a counter rotating twin-screw extruder or a single screw extruder also may be used. Raw materials (e.g., the polymer resin, the filler, and any optional additives) are introduced into the extruder via individual raw material feeders, masterbatch feeders or a combination of both feeder systems. The extruder utilizes external heating elements for temperature control and the design of the screw elements and screw revolution's per minute (RPMs) for shear to achieve the molten mixture. Screw RPMs may range from 120 to 210, including 145 to 185 as a typical range. A descending temperature profile is preferably used. Temperatures in the front section of the extruder may range from 180° C. to 250° C., including 200° C. to 220° C. as a typical range. Additional raw materials may be added in the middle section of the extruder. In addition, the middle section of the extruder may be used to exhaust or vent VOC's (volatile organic compounds) from the mixture. The screw elements in this section are designed as appropriate for these functions. In the descending temperature profile, temperatures in the middle section are decreasing from a range of 200° C. to 150° C., including 180° C. to 160° C. as a typical range. The raw material mixing is completed in the final section of the extruder. Temperatures in the final section of the descending temperature profile may range of 160° C. to 90° C., including 140° C. to 100° C. as a typical range. The screw elements in this section are designed as appropriate to facilitate final mixing. The extrudate (core) exits the extruder at a temperature range of 140° C. to 190° C., including 1550 to 175° C. as a typical range. The extrudate (core) then may enter a melt pump, also referred to as a gear pump, in order to homogenize the material providing less pressure variation in the dies. The extrudate (core) may enter the melt pump with pressures ranging from 5 bar (500 kiloPascals or kPa) to 50 bar (5,000 kPa), including 20 bar (2,000 kPa) to 40 bar (4,000 kPa) as a typical range. The extrudate (core) then exits the melt pump and enters the dies with a temperature range of 135° C. to 185° C., including 150° to 170° C. as a typical range. The extrudate (core) enters the dies with pressures ranging from 40 bar (4,000 kPa) to 110 bar (11,000 kPa), including 60 bar (6,000 kPa) to 90 bar (9,000 kPa) as a typical range. The dies may utilize external heating elements to control the temperatures. Dies temperatures may range from 135° C. to 200° C., including 160° C. to 180° C. as a typical range. The extrudate (core) will exit the dies with a temperature in the range of 140° C. to 185° C., including 155° to 170° C. as a typical range. After exiting the die, the extrudate (core) may be cooled, for example, by entering water-cooling tanks, spray or bath to set the extrudate's (core's) final dimensions. The cooling water temperature may range from 5° C. to 20° C., including 10° C. to 15° C. as a typical range. After cooling, the extrudate (core) is cut to specified length. At this point, the extrudate (core) is ready for surface modification, described in more detail below.

If necessary, the one or more surfaces (112, 114, 116, 118) of the core 110 may be modified through mechanical means, e.g., milling, grinding, sanding, to achieve a surface with the desired shape or smoothness. Following this extrusion process, the one or more surfaces (112, 114, 116, 118) of the core 110 are difficult to print on and/or adhere to. This difficulty may manifest itself in the form of poor adhesion (flaking or delamination upon stress), uneven spreading of the tie surface (due to poor wettability), visual defects (inability of the tie coat to thoroughly hide folds or cracks in the core), and/or other reasons not described herein. This poor ability to print on and/or adhere to the one or more surfaces (112, 114, 116, 118) may, for example, be due to the composition of the core 110, the process used to make the core, e.g., extrusion, and/or a combination of the composition and the process. This poor ability to print on and/or adhere to can be measured as the surface energy of the or more surfaces (112, 114, 116, 118) of the core 110. The one or more surfaces (112, 114, 116, 118) of the core 110 in accordance with the present disclosure, without any surface modification, has a surface energy less than 45 millinewtons/meter (mN/m).

To overcome this poor ability to print on and/or adhere to the surface, as discussed above, the surface (112, 114, 116, and/or 118) of the core 110 is subjected to a surface modification to increase the surface energy for a period of time and to a surface energy level suitable enough to print on and/or adhere to, of which the time and/or surface energy level which may vary depending on the type of printing and/or adhesion. This surface modification may also at least temporarily increase wettability of the surface. In accordance with the present disclosure, this surface modification includes increasing the surface energy to greater than or equal to (≥) 45 mN/m, including ≥48 mN/m, including ≥50 mN/m, and including ≥52.5 mN/m, including ≥55 mN/m, including ≥58 mN/m, including ≥60 mN/m, including ≥70 mN/m, and including ≥80 mN/m for a period of time up to 100 hours, including up to 72 hours, including up to 48 hours, including up to 36 hours, including up to 24 hours, including up to 20 hours, including up to 15 hours, including up to 10 hours, including up to 5 hours, including up to 2 hours, including up to 1 hour, including up to 45 minutes, including up to 30 minutes, including up to 15 minutes, including up to 10 minutes, including up to 5 minutes, including up to 1 minute, including up to 45 seconds, including up to 30 seconds, including up to 15 seconds, including up to 10 seconds, including up to 5 seconds, including 1 second, and including less than one second. Exemplary surface energy ranges following surface modification include from 45 to 80 mN/m, including from 45 to 70 nN/m, including from 45 to 60 mN/m, for an adequate period of time upon which to print on or adhere to. Exemplary surface energy ranges following surface modification include from 50 to 80 mN/m, including from 50 to 70 nN/m, including from 50 to 60 mN/m, for an adequate period of time upon which to print on or adhere to. Exemplary such adequate periods of time include times ranging from less than 1 second to 100 hours, less than 1 second to 72 hours, including less than 1 second to 48 hours, including less than 1 second to 36 hours, including less than 1 second to 24 hours, including less than 1 second to 20 hours, including 1 second to 100 hours, 1 second to 72 hours, including 1 second to 48 hours, including 1 second to 36 hours, including 1 second to 24 hours, including 1 second to 20 hours, including 1 minute to 100 hours, including 1 minute to 72 hours, 1 minute to 48 hours, including 1 minute to 36 hours, including 1 minute to 24 hours, including 1 minute up to 20 hours, including 1 hour to 100 hours, including 1 hour to 72 hours, 1 hour to 48 hours, including 1 hour to 36 hours, including 1 hour to 24 hours, including 1 hour up to 20 hours, including 1.5 hours to 72 hours, 1.5 hours to 48 hours, including 1.5 hours to 36 hours, including 1.5 hours to 24 hours, including 1.5 hours up to 20 hours, including 2 hours to 72 hours, 2 hours to 48 hours, including 2 hours to 36 hours, including 2 hours to 24 hours, and including 2 hours up to 20 hours.

Examples of exemplary forms of surface modification include, but are not limited to, etching, such as mechanical etching, chemical etching, plasma etching, corona etching, flame etching, and/or combinations thereof.

Suitable mechanical etching used herein may include any form of physical disruption to the surface such as grinding, milling, sanding, cutting, peeling, abrading, brushing or any other forms of subtractive manufacturing such that the surface energy of the core 110 increases. This mechanical etching can be part of, or separate to, the mechanical adjustment (grinding, milling, sanding, brushing) to the core 110 following extrusion as discussed above. Milling can increase the surface free energy of core 110 while concurrently squaring the board to aid in processing. The material removed should be sufficient to expose any subsurface substrate thus remove any handling contaminants, blemishes and/or bloomed agents/ingredients amongst others that may affect the surface energy and/or further processing.

Similarly, grinding the surface of the substrate can additionally or alternatively be done over the entire original surface in order to remove contaminants, blemishes and/or bloomed agents/ingredients amongst others. Grinding is conducted in gradual steps from coarse to fine grit to ensure removal of original surface material and a uniform surface finish across the subject surfaces. The grinding preferably takes the core 110 surface down to, e.g., a 220-300 grit surface finish, which is a finish suitable for coating and printing.

The mechanical modifications described herein may improve the surface energy of one of the core's surfaces (112, 114, 116, and/or 118); however this alone may not be enough to render a surface ready for coating, printing and processing. In such situations, these mechanical processes may need to be paired with the chemical and/or energy treatment methods as described in the present disclosure to achieve the desired surface energy needed for adhering the tie layer 120.

Suitable chemical etching used herein may include any form of affecting the core 110 surface material (112, 114, 116, and/or 118) through the use of chemicals applied to the surface so as to increase the surface energy. Exemplary chemical etchants that may be used include xylene, toluene, tetrahydrofuran (THF), methyl ethyl ketone (MEK), methyl tert-butyl ether (MTBE), methyl-isobutyl ketone (MIBK), isopropyl alcohol, denatured ethanol, cyclic ether, and combinations thereof. Chemical etching can be applied in any manner known in the art, such as spraying, curtain coating, roll coating, etc.

Suitable plasma etching used herein may include the generation of a plasma, with for example, a plasma torch, and applying that plasma to the surface (112, 114, 116, and/or 118) of the core 110. A plasma torch generally generates ionized plasma by subjecting a working gas to a high voltage between an anode and cathode, and the resulting plasma is blown via a nozzle supplying the working gas to the plasma torch. The working gas can be atmospheric air, e.g., a mixture of predominantly nitrogen and oxygen, or other pure forms of nitrogen or oxygen. The plasma application is controlled by any combination of selection of the working gas, the plasma torch nozzle, the distance, the number of passes by the plasma torch(es) so as to modify the surface to increase and achieve the desired surface energy, but so as to not too much heat to the core 110 which may damage, deform, or otherwise negatively affect the surface (112, 114, 116, and/or 118).

Suitable corona etching used herein may include the application of a corona surface treatment to the surface (112, 114, 116, and/or 118) of the core 110. This is generally done with a device that applies high-frequency power through a ceramic or metal electrode array across an intentional air gap onto the surface (112, 114, 116, and/or 118). The corona device can be a bare roller, a covered roller, or any other corona device. A corona treatment system generates an ionized corona discharge that increases the surface energy of the surface (112, 114, 116, and/or 118).

Suitable flame etching used herein may include the application of a flame to the surface (112, 114, 116, and/or 118) of the core 110. This is done, for example, using an Enercon Flame Plasma Treater, so as to modify the surface to increase and achieve the desired surface energy, but so as to not too much heat, burn, or pyrolyze the core 110 which may damage, deform, or otherwise negatively affect the surface (112, 114, 116, and/or 118). Flame treatment is preferably done using natural or propane gas. In two exemplary tests, an Enercon Flame Plasma Treater obtained surface energies of 62.9 and 63.4 mN/m of a core 110 after two passes as set forth in the table below:

| | |
|---|---|
| Test 1 | Test 2 |

| | | | |
|---|---|---|---|
| Resultant surface | 62.9 milliNewton/ | 63.4 | mN/m |
| energy | meter (mN/m) | | |

| | | |
|---|---|---|
| Number of passes | 2 | 2 |

| | | | | |
|---|---|---|---|---|
| Speed | 150 | ft/min | 150 | ft/min |

| | | |
|---|---|---|
| Gas | Natural gas | Propane |

| | | | | |
|---|---|---|---|---|
| Gap between flame onset | 1 | inch | 1 | inch |
| and core 110 surface | | | | |
| Output | 250 | L/min | 383 | L/min |

| | | |
|---|---|---|
| Air/gas Ratio | 10:1 | 25:1 |

Without intending to be limited by any theory, the surface modification, e.g., etching, at least temporarily rearranges the surface (112, 114, 116, and/or 118), such that polymer retreats and filler pushes toward the surface (112, 114, 116, and/or 118) to thereby provide reactive sites or at least anchor points on the newly exposed filler to which the opaque tie layer 120 can adhere. Alternatively or in addition, the surface treatment, e.g., etching, at least temporarily removes the additives or the surface effects of any such additives present in the core 110, thereby modifying the surface energy of the surface to more readily accept adhesion with the opaque tie layer 120.

### Tie Layer

The exterior composite board 100 of the present disclosure comprises an opaque tie layer 120 disposed on at least one surface (112, 114, 116, 118) of the core 110. The opaque tie layer 120 comprises a cured polymeric resin formed from an acrylic and/or urethane polymer coating composition. Any such self-crosslinking (e.g., self, moisture, thermal and/or UV curing) acrylic, urethane, and/or acrylic-urethane polymeric coating compositions or two-part acrylic, urethane, and/or acrylic-urethane polymeric coating composition system which when applied and cured on the etched core 110, (a) having a thickness ranging from 7 μm to 85 μm, including 15 μm to 85 μm, including 20 μm to 80 μm, and including 25 μm to 75 μm, (b) having a CIELAB L color value ranging from 60-100, including 70-100, including 80-100, including 90-100, including 80-90, including 82-88, including 70-80, and including 72-78 (c) which has an opacity value of 50%-100%, including 80%-100%, including 85%-100%, including 90%-100%, including 91%-100%, including 92%-100%, including 93%-100%, including 94%-100%, including 95%-100%, including 80%-99%, including 85-99%, including 90%-99%, including 91%-99%, including 92%-99%, including 93%-99%, including 94%-99%, including 95%-99%, including 55%-95%, and including 60%-80%, and (d) having an adhesive value of less than 5% material loss, including no material lost, with respect to its adhesion to the core 110 under the Cross-Cut Tie Layer Tape Test, is suitable for use as the tie layer of the present disclosure. Nonlimiting examples of commercially available self-crosslinking or two-part system polymeric coating compositions suitable for the tie layer include Part A Tailor Made Polymers (Pennsylvania) TMP51010DTP urethane and acrylic resin/Part B Vencorex (Texas) EASAQUA M501 isocyanate resin, AkzoNobel (Netherlands) urethane UV cure resin 972-1397, AkzoNobel urethane UV cure resin 972-1398, Kleiberit (Germany) urethane moisture cure resin VP 9383/644, Day Break Technologies (North Carolina) SCD1-23-4 acrylic resin, and RedSpot IA74-2-502A (available from RedSpot Paint and Varnish, Inc. of Indiana) polyurethane thermal cure resin. The tie layer coating composition may be applied by any suitable methods, including roll, curtain, spray, and spin coating. Although some tie layer coating compositions may be self-crosslinking, additional forms of curing assistance, such as thermal, electron beam, and/or UV may be used to assist and/or quicken the cure. Multiple passes or layers of the tie layer coating compositions may be applied and cured (or at least partially cured between passes), and the entirety of those layers/passes comprise the tie layer 120.

As discussed above, the tie layer itself provides a suitable substrate and background color uniformity for additional printed layers applied over the tie layer 120.

Also as discussed above, the exterior composite board 100 of the present disclosure preferably comprises at least one of an optional primer layer 160 and an optional textured layer 130. As such, the respective primer layer 160 and textured layer 130 as discussed herein are individually referred to as “optional” such that at least one of them is preferably present in the board disposed between the tie layer 120 and color layer 140, although each or both do not need to be there. As used herein, it should be understood that “optional primer layer” is interchangeable with “primer layer” and “optional textured layer” is interchangeable with “textured primer layer.” Accordingly, in exemplary aspects of the present disclosure, the exterior composite board 100 comprises an optional primer layer 160 and no optional textured layer 130 as shown in FIG. 2C. In other aspects, the exterior composite board 100 comprises an optional textured layer 130 and no optional primer layer 160 as shown in FIGS. 1 and 2A. In other aspects, the exterior composite board 100 comprises both an optional primer layer 160 and an optional textured layer 130 as shown in FIG. 2B. In other aspects, the exterior composite board 100 comprises neither an optional primer layer 160 nor an optional textured layer 130 (FIG. 2D).

### Optional Textured Layer

The exterior composite board 100 of the present disclosure comprises an optional textured layer 130 disposed on the opaque tie layer 120. The optional textured layer 130 comprises a cured polymeric resin and has surface features defined by a varying depth. This is most clearly illustrated in FIGS. 2A and 2B (which are not to scale and features may be exaggerated for illustrative purposes), which show the surface adjacent to the tie layer as relatively smooth and even, and the surface adjacent to the next layer (the color layer 140) having a variable depth (or height depending on the perspective). The thickness of the optional textured layer 130 ranges from 1 to 150 μm, and as mentioned above, varies in depth. The optional textured layer 130 comprises a cured acrylic, urethane, and/or acrylic urethane polymeric resin in which the resin is digitally printed and pinned (at least partially cured shortly or immediately after applied with the printer) on the opaque tie layer 120. Preferably, the resin used in this layer cures so as to facilitate another printing and pinning pass of additional resin so as to build up the resin and form the varying depth “texture” of the optional textured layer 130. As such, it should be understood that the optional textured layer 130 may comprise multiple layers or passes of polymeric resin digitally printed and pinned by a digital printer, with the entirety of those layers/passes comprising the optional textured layer 130. Exemplary curable polymeric resins that can be used include any rapidly curable polymeric resins such as UV or electron beam curable acrylic resins. UV and/or electron beam curable resins work well to pin the resin during printing so as to quickly facilitate additional passes of the resin used in this and other layers of the exterior composite board 100 of the present disclosure. Exemplary commercially available resins suitable for the textured layer 130 include UV curing acrylate resins from suppliers including, but not limited to, Bonet, Aditivos Cerimicos, CCB Colors, Chimigraf, Coloresmalt (SAMCA), Colorobbia, ColorOnda, Colores, Olucha, Colores Cerimicos (SIC), Decoroil, Colorminas, DEF, Esmaltes S.L., Farper, Ferro, Fritta, Gesuncer, Hydra, Inco, Emalglass-Itaca, Kerafrit, Manchester, Megacolor, Metco, Quimicer, Salquisa, Sicer, Silpo, Smalticeram, Smaltochimica, Tiger Coatings, Torrecid, Vidres, Vernis, Vetriceramici, Wan Xing, and Zschimmer. Nonlimiting examples of suitable commercially available UV and/or electron beam curable resins suitable for the textured layer include Tiger Coatings (Germany) Tigital Series 134 and 135 acrylic resins.

The polymeric resin used to form the optional textured layer 130 may or may not comprise pigments in addition to the polymeric resin. In certain aspects, the optional textured layer is transparent 130. Given that the opaque tie layer is opaque so as to provide a suitable background color, and given that the exterior product boards 100 of the present disclosure has color layer 140, the optional textured layer 130 does not include any intentionally added pigments in the polymeric resin. As such, the optional textured layer 130, when cured, has an opacity value of 0 to 10%. In other words, the optional textured layer 130, when cured, may be considered clear or transparent.

The polymeric resin used to form the optional textured layer 130 has a viscosity of 9 to 35 milli-Pascal seconds (mPas) at 25° C. and 3-13 mPas at 50° C.

Any suitable digital printer capable of printing such resins is suitable for use to create the optional textured layer 130. In accordance with certain aspects of the present disclosure, the pinning component (e.g., UV and/or electron beam) is part of the printer, e.g., the digital printer comprises an ink jet component and the pinning component. In other aspects, the printing components (such as an ink jet component) and the pinning component are not part of the same device and are implemented separately during the manufacture of the exterior composite boards 100 of the present disclosure.

The optional textured layer 130 can provide a visual and three-dimensional pattern resembling conventional construction materials, such as wood, stone, masonry, etc.

If not satisfactorily cured (which may require it to be fully cured) from each pass, the optional textured layer 130 may be fully or completely cured using the appropriate curing means, e.g., UV and/or electron beam, and for the appropriate amount of time to complete the curing. This period of time may depend on the form and intensity of the curing means.

### Color Layer

The exterior composite board 100 of the present disclosure comprises a color layer 140 disposed on the tie layer 120, or if present, the optional primer layer 160 or the optional textured layer 130. The color layer 140 comprises a cured polymeric resin and an inorganic ink. Suitable polymeric resin that may be used for the color layer 140 include, but are not limited to, the acrylic, urethane, and/or acrylic-urethane polymeric resins used for the optional primer layer 160 and/or optional textured layer 130 disclosed herein. Accordingly, the polymeric resin of the color layer 140 may be the same or similar as that of the optional primer layer 160 and/or optional textured layer 130. Although they can be the same, this does not mean that the polymeric resin of the color layer 140 must be the same as the adjacent polymeric resin of the optional primer layer 160 and/or optional textured layer 130 on the same exterior composite board. These two adjacent resins can be different relative to each other but should each preferably be respectively suitable and compatible polymeric resins. Exemplary commercially available resins suitable for the color layer 130 include UV curable acrylate resins from suppliers including, but not limited to, Bonet, Aditivos Cerimicos, CCB Colors, Chimigraf, Coloresmalt (SAMCA), Colorobbia, ColorOnda, Colores, Olucha, Colores Cerimicos (SIC), Decoroil, Colorminas, DEF, Esmaltes S.L., Farper, Ferro, Fritta, Gesuncer, Hydra, Inco, Emalglass-Itaca, Kerafrit, Manchester, Megacolor, Metco, Quimicer, Salquisa, Sicer, Silpo, Smalticeram, Smaltochimica, Tiger Coatings, Torrecid, Vidres, Vernis, Vetriceramici, Wan Xing, and Zschimmer. Nonlimiting examples of a suitable commercially available UV and/or electron beam curable resins suitable for the color layer include Tiger Coatings (Germany) Tigital Series 134 and 135 acrylic resins.

Suitable inorganic pigments that may be used for the color layer 140 include, but are not limited to, metal oxides, silicates, aluminates, phosphates, sulfates, sulfides, selenides, nitrites, and/or combinations thereof. More specific nonlimiting examples include iron oxides, titanium dioxide (TiO₂ or titanium white), titanium oxide (Ti₂O₃ or titanium black), cobalt blue, Han blue, chrome green (chromium(III) oxide), cobalt green, Primrose yellow, chrome yellow, yellow ochre, cadmium red, red ochre, lead tetraoxide (red lead), raw umber, raw sienna, carbon black, lamp black, iron black, manganese dioxide, barium sulfate, zinc oxide (zinc white), antimony white, and/or combinations thereof.

The color layer 140 comprising a polymeric resin in combination with an inorganic pigment is preferably digitally printed on the optional primer layer 160 and/or optional textured layer 130. The color layer 140 comprising a polymeric resin in combination with an inorganic pigment may alternatively be digitally printed on the tie layer 120. The color layer 140 can comprise a single color. Alternatively, the color layer 140 comprises any different number of applied layers, for example, up to four different applied layers selected from a cyan color layer, a magenta color layer, a yellow color layer, and a black color layer. Unless otherwise indicated herein, the color layer 140 may refer to a single layer of up to four different applied layers selected from a cyan color layer, a magenta color layer, a yellow color layer, and a black color layer, or all four of those different color layers (combined) together. As is known in the field of printing, a digital printer can use combinations of these four colors to create any desired color on the exterior composite boards 100 of the present disclosure. In other words, these four color layers may be registered so as to result in the desired color. Each of the up to four different applied color layers are at least partially cured (at least partially pinned) prior to the application any remaining other different applied color layers for the particular color scheme on the board 100. This partial or full curing helps prevent the different colors from bleeding or weeping into previously or subsequently applied layers. If not fully cured after all of the up to four different applied layers selected from a cyan color layer, a magenta color layer, a yellow color layer, and a black color layer are printed, the color layer 140 may be fully or completely cured using the appropriate curing means, e.g., UV and/or electron beam, and for the appropriate amount of time to complete the curing. This period of time may depend on the form and intensity of the curing means.

The color layer 140 provides a visual pattern on the exterior composite board 100. This pattern can resemble conventional construction materials, such as wood, stone, masonry, etc. Because the primary use of this board 100 is outdoors, the board is subject to UV fading. In a preferred aspect of the present disclosure, when inorganic pigments are used, the visual pattern formed by the color layer retains color at a value of less than 5 units of Delta E over 5,000 hours, and in certain aspects over 10,000 hours, of exposure as measured in accordance with the QUV Weathering Test. In other words, the CIELAB E value of the color pattern of the exterior composite board changes less than 5 units when tested over 5,000 hours, and in certain aspects over 10,000 hours, under the QUV Weathering Test of the present disclosure.

The thickness of the color layer 140 ranges from 6 μm to 48 μm, and including 12 μm to 24 μm with each individual cyan color layer, magenta color layer, yellow color layer, and black color layer respectively ranging from 6 μm to 48 μm, including 3 μm to 6 μm, and including 1.5 μm to 12 μm. The color layer 140 (as shown in FIGS. 2A and 2B) or each individual cyan color layer, magenta color layer, yellow color layer, and black color layer can respectively have a substantially uniform thickness, or the color layer 140 or each individual cyan color layer, magenta color layer, yellow color layer, and black color layer can respectively have a thickness of varying depth (not shown).

The polymeric resin and inorganic ink used to form the color layer 140 preferably has a viscosity of 8 to 11 mPas at 50° C.

Any suitable digital printer capable of printing such resins is suitable for use to create the optional primer layer 160 and/or optional textured layer 130 as disclosed herein and may be used to print the color layer 140. Furthermore, it is believed that rotogravure printing and/or transfer foil decorating techniques known to those skilled in the art can be used in addition to digital printing or as an alternative to digital printing for the color layer 140 as well as the optional textured (130), and primer layers (160) of the present disclosure.

### Protective Layer

The exterior composite board 100 of the present disclosure comprises a protective layer 150 disposed on the color layer 140. The protective layer 150 is the outermost layer on the exterior composite board and, as such, provides resistance to weathering and/or abrasion. The protective layer comprises a cured polymeric resin formed from a coating composition. Any resin, which when cured on an exterior composite board 100 and having a thickness ranging from 25 to 200 μm and is suitable from −20° F. to 125° F. (approximately −29° C. to 52° C.) and that (a) retains color at a value of less than 5 units of Delta E over 5,000 hours, and in certain aspects over 10,000 hours, of exposure as measured in accordance with the QUV Weathering Test of the present disclosure (in other words, CIELAB E value of the resin changes less than 5 units when tested over 5,000 hours, and in certain aspects over 10,000 hours, under the QUV Weathering Test), (b) provides greater than or equal to 2,000 cycles wear resistance according to the Abrasion Resistance Test of the present disclosure, and (c) has a gloss value less than or equal to (<) 4 when measured at 60° angle (measured on BYK micro-TRI-gloss meter), is suitable for the protective layer 150.

Examples of suitable polymeric resin coating compositions for use with the protective layer 150 include acrylic resins, urethane resins, and acrylic-urethane resins, including thermal, moisture, UV, and/or electron beam curable forms of these resins. In certain aspects, the coating compositions are water-based. Specific examples of commercially available protective coatings include, but are not limited to, a polyurethane-based hotcoat applied at 100-160° C. Those skilled in the art can select other comparable resins suitable for the color layer from suppliers including RedSpot, Day Break Technologies, Tailor Made Polymers, PENN, AkzoNobel, PPG, and Kleiberit. Nonlimiting examples of commercially available acrylic resins, urethane resins, and acrylic-urethane resins suitable for the protective layer include Tailor Made Polymers TMP60225XP acrylic resin, AkzoNobel urethane UV cure resin 972-1404, AkzoNobel acrylic UV cure resin 972-1400, Kleiberit urethane hot melt resin 9383/627, Kleiberit acrylic UV cure resin 659.2.22, Day Break Technologies SCD1-48-1 acrylic UV cure resin, and RedSpot IA74-2-510 polyurethane thermal cure resin.

The protective layer 150 or the coating composition used to for the protective layer 150 may further include additives comprising any one or more of antioxidants, light stabilizers, antiblocking agents, heat stabilizers, impact modifiers, biocides, antimicrobial additives, compatibilizers, plasticizers, tackifiers, processing aids, lubricants, coupling agents, flame retardants, UV reflective additives, infrared reflective additives, thermally conductive additives, and/or combinations thereof. The protective layer 150 may comprise from 0 to 10% by weight additive based on the total weight of the protective layer 150 coating composition.

The protective layer coating composition may be applied by any suitable methods, including roll, curtain, spray, and spin coating. Additional forms of cure assistance can be applied to assist in curing the protective coating, including using moisture, thermal, electron beam or UV lights may be used to assist and/or quicken the cure. More than one layer or pass of the protective layer coating composition may be applied to the exterior boards 100 of the present disclosure to form the protective layer 150, with at least partial curing prior to application of successive layers of the coating composition. It should be understood that the entirety of those layers/passes comprise the protective layer 150.

When cured, the thickness of the protective layer 150 ranges from 25 μm to 200 μm, including 25 μm to 175 μm, including 25 μm to 150 μm, including 25 μm to 125 μm, including 50 μm to 200 μm, including 50 μm to 175 μm, including 50 μm to 150 μm, including 50 μm to 125 μm, including 75 μm to 200 μm, including 75 μm to 175 μm, including 75 μm to 150 μm, including 75 μm to 125 μm, including 85 μm to 125 μm, including 90 μm to 120 μm, including 95 μm to 115 μm, including 30 μm to 60 μm, and including from 35 μm to 55 μm.

The polymeric resin used to form the protective layer 150 is transparent. Because it is transparent, the protective layer 150 does not include any intentionally added pigments in the polymeric resin. As such, these the protective layer 150 when cured has an opacity value of 0-10%.

### Optional Primer Layer

The exterior composite board 100 of the present disclosure may optionally further comprise a primer layer 160 disposed between the tie layer 120 and the color layer 140 or, if present between the tie layer 120 and the optional textured layer 130. The optional primer layer 160 is useful to promote adhesion between the tie layer 120 and the color layer 140 or, if present, between the tie layer 120 and the optional textured layer 140. Suitable polymeric resins that may be used for the optional primer layer 160 include, but are not limited to, the acrylic, urethane and/or acrylic-urethane polymeric resins used for the optional textured layer 130 and/or the color layer 140 disclosed herein. Accordingly, the polymeric resin of the primer layer 160 may be the same as that of the optional textured layer 130 and/or the color layer 140. Although they can be the same, this does not mean that the polymeric resin of the primer layer 160 must be the same as that of adjacent polymeric resin of the optional textured layer 130 or the color layer 140 on the same exterior composite board. These resins can be different relative to each other as long as they are each respectively suitable polymeric resins. Primer layer 160 may be at least partially cured, if not fully cured, prior to applying the next respective layer, e.g., the optional textured layer 130 or the color layer 140.

The exterior composite board 100 of the present disclosure may optionally further comprise a primer layer disposed between the optional textured layer 130 and the color layer 140 (not shown), and/or a primer layer disposed between the color layer 140 and the protective layer 150 (not shown). Similar to above, these respective additional optional primer layers are useful to promote adhesion between other layers. Suitable polymeric resins that may be used for these additional primer layers include, but are not limited to, the acrylic, urethane and/or acrylic-urethane polymeric resins used for the textured layer 130 disclosed herein. Similar to above, these additional optional primer layers may be at least partially cured, if not fully cured, prior to applying the next respective layer, e.g., the color layer 140 and/or the protective layer 150. Furthermore, multiple passes or layers of the optional primer layer coating compositions may be applied and cured (or at least partially cured between passes), and the entirety of those layers/passes comprise the optional primer layer 160.

The polymeric resin used to form the optional primer layer(s) (e.g., 160) may have a viscosity of 9 to 35 mPas at 25° C. and 3-13 mPas at 50° C. The optional primer layer can have a thickness of 3 μm to 50 μm, including from 3 μm to 40 μm, including from 10 μm to 30 μm and including from 10 μm to about 20 μm when cured.

The polymeric resin used to form the optional primer layer(s) (e.g., 160) may or may not comprise pigments in addition to the polymeric resin. In certain aspects, the optional primer layer(s) (e.g., 160) is transparent. Given that the opaque tie layer is opaque so as to provide a suitable background color, and given that the exterior product boards 100 of the present disclosure has color layer 140, the optional primer layer(s) 160 may not include any intentionally added pigments in the polymeric resin. As such, these the optional primer layer(s) 160 when cured has an opacity value of 0-10%.

The optional primer layer(s) 160 may be applied by any suitable methods, including roll, curtain, spray, and spin coating. Furthermore, the optional primer layer(s) 160 may be printed in the same manner as the optional textured layer 130 and/or the color layer 140. Additional forms of cure assistance can be applied to assist in and/or quicken curing the protective coating, including using thermal, electron beam, and/or UV lights.

Any suitable digital printer capable of printing such resins is suitable for use to create the optional textured layer 130 and/or the color layer 140 as disclosed herein and may be used to print the optional primer layer(s) 160.

### Exterior Composite Board

The exterior composite board 100 of the present disclosure can be used as exterior composite decking boards, exterior cladding (e.g., siding), and other elongated thermoplastic-based building materials. As discussed above, each of the textured (130) and color (140) layers provides a pattern on the board which may resemble other conventional construction materials, wood, stone, masonry, etc.

Due to its exposure to the elements, the exterior composite board 100 formed according to the present disclosure in accordance with FIG. 2C (with a protective layer 150 comprising a UV cured acrylic resin disposed over a urethane cured resin layer) has the following in accordance with Table 1.

TABLE 1

| TEST/PROCEDURE | METHOD | RESULT |
|---|---|---|
| ABRASION | EN13329:200016 + | ≥AC2 ≥ 1000 |
| RESISTANCE | A2:2021 | cyles |
| CROSS HATCH | ASTM D 3359-B - 23 | 4B-5B (<5% |
| ADHESION TESTING | | material loss) |
| ACCELERATED | ASTM D7032-21 | Flexural |
| WEATHERING | (2000 hours QUV) | Loss < 10% |
| (Codes Comp.) | | |
| COEFFICIENT OF | ASTM F 1679-04 | 0.4 Dry/0.31 Wet |
| STATIC FRICTION | | |
| GLOSS LEVEL | Glossmeter @ | <5.0 GU |
| | 60 degree | |
| FLAME SPRED INDEX | ASTM E 84-23d | <200 (Class C) |
| FORMOSAN TERMITE | AWPA STD E1-09 | Pass |
| RESISTANCE RATING | | |
| MOLD | ASTM D 3273-21 | No significant |
| TESTING | | growth |
| FUNGUS DECAY | ASTM D 1413-07 | No significant |
| RESISTANCE | | decay |
| IMPACT | EN13329:200016 + | ≥10 mm |
| RESISTANCE - | A2:2021/EN438-2:2016 + | |
| SMALL BALL | A1:2019 | |
| IMPACT | EN13329:200016 + | ≥500 mm |
| RESISTANCE - | A2:2021/EN438-2:2016 + | |
| LARGE BALL | A1:2019 | |

The exterior composite board 100 of the present disclosure, when used as a deck board, can have the dimensions of standard dimensional lumber, 2″×4″ (˜5 cm×˜10.2 cm), 2″×6″ (˜5 cm×˜15.2 cm), 2″×8″ (˜5 cm×˜20.3 cm), 2″×10″ (˜5 cm×˜25.4 cm), 2″×12″ (˜5 cm×˜30.5 cm), etc. at varying lengths, 8′ (˜2.4 m), 10′ (˜3 m), 12′ (˜3.7 m), 20′ (˜6 m), 22′ (˜6.7 m), etc. For the avoidance of doubt, ″=inches, and ′=foot, and 1 inch=2.54 cm, and 1 foot=30.48 cm.

### Method of Manufacturing

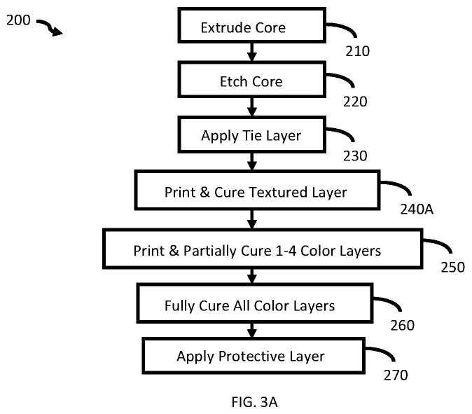

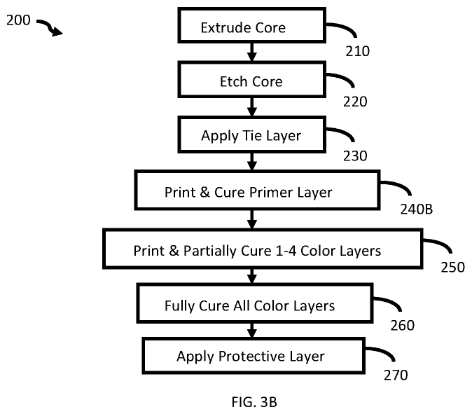

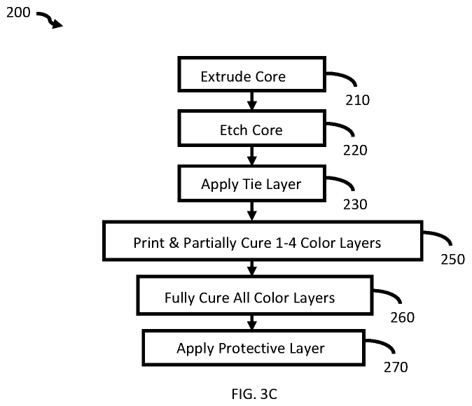

The present disclosure is also directed to methods of making the exterior composite board 100. FIGS. 3A, 3B, and 3C provide exemplary manufacturing methods in accordance with the present disclosure. The method comprises extruding a core (210) comprising a polymeric resin in accordance with those disclosed herein and a filler in accordance with those disclosed herein. For example, the polymeric resin comprises a polyethylene (PE), polypropylene (PP), a polyethylene terephthalate (PET), a thermoplastic elastomer (TPE), or combinations thereof, and the filler comprises an organic filler, a mineral filler, or combinations thereof. The extruded core has a top surface 112, a bottom surface 114 opposing the top surface 112, a left side surface 116, and a right side surface 118 opposing the left side surface 116, the left 116 and right side 118 surfaces each extend between the top surface 112 and the bottom surface 114. The extrusion is accomplished using any extruder capable of extruding the polymeric resin and filler materials disclosed herein, for example, single or multiscrew extruders. The die used in extrusion can be selected depending on desired shape and dimensions of the exterior composite board 100.

Following extruding, the method includes etching (220) at least one surface (112, 114, 116, and/or 118) of the core 110 to form at least one etched surface (112, 114, 116, and/or 118). Exemplary forms of etching include those disclosed herein, e.g., at least one of the following surface treatments: mechanical etching, chemical etching, plasma etching, corona etching, flame etching, or combinations thereof. The etching modifies the at least one surface of the core (112, 114, 116, and/or 118) so as to improve adhesion to the cured opaque tie layer 120. In particular, the etching increases the surface energy as discussed herein for a period of time as discussed herein, and this increase in surface energy allows for adhesion of a tie layer 120 to the at least one surface (112, 114, 116, and/or 118) of the core 110 as disclosed herein.

For the period of time in which the surface is still modified following etching, e.g., when the surface energy following etching is greater than or equal to 45 mN/m on the at least one etched surface (112, 114, 116, and/or 118), the method comprises applying a tie layer coating composition (230) to the at least one etched surface (112, 114, 116, and/or 118) and curing the tie layer coating composition to form cured opaque tie layer 120 on the at least one etched surface (112, 114, 116, and/or 118). Once the opaque tie layer has been applied to the core 110, the method comprises applying, e.g., digitally printing, preferably at least one of: (a) an optional primer layer polymeric resin on the tie layer, and (b) an optional textured layer polymeric resin on the tie layer 120, or if a primer layer is present, on the primer layer 160, and curing the primer layer polymeric resin (240B) and/or textured layer polymeric resin (240A), the textured layer 130 having surface features defined by a varying depth.

The method then includes the step of digitally printing up to four independent color layers comprising a color layer polymeric resin and inorganic ink on the opaque tie layer 120 (according to FIG. 3C), or if present, on the optional primer layer 160 or the optional textured layer 130 and at least partially curing each printed color layer before printing the next color layer (250). The layers, for example, up to four color layers 140, are selected from a cyan color layer, a magenta color layer, a yellow color layer, and a black color layer. Following the at least partial curing of the last of the exemplary up to four different color layers 140, the method comprises fully curing (260) all of the up to four color layers 140.

Lastly, the method comprises applying a protective layer polymeric resin (270) to the exemplary up to four color layers 140 and curing the protective layer polymeric resin to form the protective layer 150, wherein the cured protective layer 150 provides resistance to weathering and abrasion.

During the method, the exterior composite board may be cut into desired lengths suitable for use in construction as disclosed herein. This step may occur at various points in the process, e.g., after extrusion (210), after applying the tie layer (230), after printing the optional texture (240A), after printing the optional primer (240B), after printing the color (250 or 260), or after adding the protective layer (270).

Optionally, the method further may comprise additionally applying or printing one or more optional primer layer(s) 160 as disclosed herein between the optional textured layer 130 and the color layer 140, and/or between the color layer 140 and/or protective layer 150.

The method of manufacture may include a single, continuous process (e.g., a single manufacturing line starting with the extrusion of the core and ending with the completed exterior product board 100) or the steps may be broken up with the limitation of the etching (220) and application of the tie layer (230) being completed in with the time period in which the surface modification of the core is still active, e.g., completed while the surface energy is greater than or equal to 45 mN/m.

### Analytical Methods

### Cross-Cut Tie Layer Tape Test

The Cross-Cut Tie Layer Tape Test is done in accordance with ASTM D3359-23—Test Method B—Cross-Cut Tape Test, and the results are classified in accordance with Table 2 (which is FIG. 1 from ASTMD3359 Test Method B). Testing should be conducted at room temperature (i.e. 25° C.±5° C.) on a tie layer 120 surface free of blemishes and minor surface imperfections. For the tie layer 120, which has a dry film thickness not to exceed 50 μm (2 mil), the spacing between each parallel cut line should be 1 mm for a total of 6 parallel lines. Cuts are made about 20 mm (¾ inch) in length. The cuts should cut through the tie layer 120 into the substrate 110 in one steady motion. After making the first set of 6 parallel cut lines, the process is repeated but cutting perpendicular to the initial 6 cut lines. After making the required cuts, the test area should have 12 cut lines (6 in one direction and 6 in the perpendicular direction) creating a test area of 5 mm×5 mm grid with squares that are 1 mm×1 mm in dimension; totaling 25 squares (each square representing 4% of the total test area). With a brush, the test area is cleaned and any by product created during preparation (flakes, dust, fibers, etc) is removed. Then, a 75 mm (3 inch) piece tape is applied to the test grid with the center of the tape over the grid. Suitable tapes for this test should have adhesive peel strength on steel of 6.34 N/cm (58 oz/in)-7.00 N/cm (64 oz/in) per ASTM D3330. After applying the tape (<2 mins of application) and ensuring there is no air bubbles, the tape is peeled in a swift rapid smooth motion at nearly 180° angle (i.e., parallel to the test surface). The test area is inspected aided with an illuminated magnifier and the results compared with Table 2 to determine the percentage area of the material removed by the tape.

### Cross-Cut Protective Layer Tape Test

The Cross-Cut Protective Layer Tape Test is done in the same manner as the Cross-Cut Tie Layer Tape Test, except that the surface tested is the protective layer 150 (the complete or finished exterior composite board 100) instead of the tie layer 120. Also, the spacing used between the parallel cut lines depends on the total thickness of all of the layers (i.e., the combined thickness of the tie layer 120, optional primer layer 160 and/or optional textured layer 130, color layer 140, and protective layer 150) applied over the core 110. In particular, if the total thickness of all of the layers is from 50-125 μm (2-5 mils), the parallel cut lines on the protective layer should be 2 mm apart. If the total thickness of all of the layers exceeds 125 μm (5 mils), the parallel cut lines should be 3 mm apart. The results are compared with Table 2 to determine the percentage area of the material removed by the tape.

### QUV Weathering Test

The QUV Weathering Test is conducted in accordance with ASTM G154-23. More specifically a Q-Lab, QUV/Spray weathering chamber set with Q-Lab UVA 340 and Florescent UV Lamps is used for the tests. Specimens of the exterior composite board tested are approximately 3 inches×6 inches×0.25 inches (specimens are taken from the top surface of the board 100, including the tie layer 120, optional primer layer 160 and/or optional textured layer 130, color layer 140, and protective layer 150 and a portion of the core 110). The CIELAB E testing color is recorded at 0 hrs and every 1000 hrs subsequently using a spectrophotomer (DataColor 700) for up to 10,000 hrs. If samples are multichromatic, the area tested is marked prior to exposure to ensure testing is conducted repeatedly on the same location. If samples are monochromatic, testing can be conducted on any part of the exposed surface. After documenting the initial CIELAB values, the samples are mounted on the QUV sample holder of Q-Lab UVA 340 with sample window facing in towards the lamps. Samples are retested every 1000 hrs up to 10,000 hrs documenting the changes in CIELAB E value.

### Surface Energy

Unless otherwise specified herein, the surface energy is determined using contact angles of polar and non-polar liquids on the surface of the core 110. More specifically, a Mobile Surface Analyzer (MSA) manufactured by KRUSS measures the contact angles of distilled water (polar) and diiodo methane (non-polar) on the core 110 surface and calculates the surface energy using the Owens-Wendt-Rabel & Kaelble (OWRK) model.

### Opacity

Unless otherwise specified herein, the opacity is determined using a spectrophotometer (Data Color 700). Specifically, opacity of the specimen is measured in reflectance mode to measure translucency in a scale called Contrast Ratio (CR), a scale calculated up to a value of 100 which represents an opaque coating. CR measurements are calculated measuring the coated specimen twice; once against a white background followed by a measurement against a black background (i.e., Opacity Leneta Charts).

### Abrasion Resistance Test

The Abrasion Resistance Test is conducted in accordance with EN 13329—Annex E. Specifically, after calibration, 180 grit (aluminum oxide) abrasive paper is loaded on to S-32 abrasion wheels on a Taber Model 5130 abrader machine with 500 gram weigh on each wheel. and the specimen are loaded on to a Taber Model 5130 abrader machine, and the machine and is run for 200 cycles, before replacing with fresh abrasive paper. After 50 cycles, the specimen is inspected for abrasion. The procedure is repeated until abrasion at an area of 0.6 mm² is observed on the specimen.

The terminology as set forth herein is for description of the embodiments only and should not be construed as limiting the disclosure as a whole. All references to singular characteristics or features of the present disclosure shall include the corresponding plural characteristic or feature, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” or “and/or” is employed (e.g., A or B, or A and/or B) it is intended to mean “A or B or both.” When the applicants intend to indicate “only A or B but not both” then the term “only A or B but not both” will be employed. Thus, use of the term “or” herein is the inclusive, and not the exclusive use.

The exterior composite boards of the present disclosure can comprise, consist of, or consist essentially of the essential elements of the disclosure as described herein, as well as any additional or optional element described herein or which is otherwise useful in the boards.

All percentages, parts, and ratios as used herein are by weight of the total composition, unless otherwise specified. All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

The term “about” as used herein means approximately, in the region of, roughly, or around. When the term “about” is used in conjunction with a numerical range, it modifies that range by extending the boundaries above and below the numerical values set forth.

Any combination of method or process steps as used herein may be performed in any order, unless otherwise specified or clearly implied to the contrary by the context in which the referenced combination is made.

1. An exterior composite board, comprising:
a core comprising
a polymeric resin comprising a polyethylene (PE), polypropylene (PP), a polyethylene terephthalate (PET), a thermoplastic elastomer (TPE), or combinations thereof, and
a filler comprising an organic filler, a mineral filler, or combinations thereof,
the core having a top surface, a bottom surface opposing the top surface, a left side surface, and a right side surface opposing the left side surface, the left and right side surfaces each extend between the top surface and the bottom surface;
an opaque tie layer disposed on at least one surface of the core, the opaque tie layer comprising a cured polymeric resin;
at least one of:
a primer layer disposed on the tie layer comprising a cured polymeric resin, and
a textured layer disposed on the tie layer or, if a primer layer is present, on the primer layer, the textured layer comprising a cured polymeric resin, the textured layer having surface features defined by a varying depth;
a color layer disposed on the at least one of the primer layer and textured layer, the color layer comprising a cured polymeric resin and an inorganic ink; and
a protective layer,
wherein the adhesive value between the tie layer and at least one surface of the core upon which the tie layer is disposed has less than about 5% of material removed according to the Cross-Cut Tie Layer Tape Test.

2. The exterior composite board of claim 1, wherein the polyethylene (PE) comprises linear low density polyethylene (LLDPE), low density polyethylene (LDPE), medium density polyethylene (MDPE), high density polyethylene (HDPE), ultra-high molecular weight polyethylene (UHMWPE), or combinations thereof.

3. (canceled)

4. The exterior composite board of claim 1, wherein the organic filler comprises a cellulosic material, an organic polymer fiber, biochar, or combinations thereof.

5. (canceled)

6. The exterior composite board of claim 1, wherein the mineral filler comprises talc, mica, clay, feldspar, diatomaceous earth, fumed silica, amorphous silica, fumed aluminum oxide, sand, wollastonite, calcium carbonate, carbon black, glass fibers, glass beads, or combinations thereof.

7. The exterior composite board of claim 1, wherein the cured polymeric resin of the opaque tie layer is formed from an acrylic or urethane polymer coating composition.

8. (canceled)

9. The exterior composite board of claim 1, wherein the opaque tie layer has an opacity value of 90%-100%.

10. The exterior composite board of claim 1, wherein the cured polymeric resin of the at least one of a primer layer and a textured layer comprises an acrylic or urethane polymeric resin.

11. The exterior composite board of claim 1, wherein the cured polymeric resin of the color layer comprises an acrylic or urethane polymeric resin.

12. The exterior composite board of claim 1, wherein the color layer comprises up to four different applied layers selected from a cyan color layer, a magenta color layer, a yellow color layer, and a black color layer.

13. The exterior composite board of claim 1, wherein the CIELAB Delta E of the exterior composite board is less than 5 units when tested over 10,000 hours under the QUV Weathering Test.

14. The exterior composite board of claim 1, wherein a primer layer is disposed between the opaque tie layer and the color layer.

15. The exterior composite board of claim 1, wherein for a period of time prior to the application of the opaque tie layer, at least one surface of the core has a surface modification such that it has a higher surface energy than the same surface of the core without the surface modification.

16. The exterior composite board of claim 1, wherein exterior composite board is a deck board.

17. A method for manufacturing an exterior composite board, comprising:
extruding a core comprising a polymeric resin and a filler,
the polymeric resin comprising a polyethylene (PE), polypropylene (PP), a polyethylene terephthalate (PET), a thermoplastic elastomer (TPE), or combinations thereof, and
the filler comprising an organic filler, a mineral filler, or combinations thereof,
the core having a top surface, a bottom surface opposing the top surface, a left side surface, and a right side surface opposing the left side surface, the left and right side surfaces each extend between the top surface and the bottom surface;
etching at least one surface of the core to form at least one etched surface;
applying a tie layer coating composition to the at least one etched surface and curing the tie layer coating composition to form cured opaque tie layer on the at least one etched surface, wherein the step of etching modifies the at least one surface of the core so as to improve adhesion to the cured opaque tie layer,
digitally printing at least one of: (a) a primer layer polymeric resin on the tie layer, and (b) a textured layer polymeric resin on the tie layer, or if a primer layer is present, on the primer layer, and curing the primer layer polymeric resin or textured layer polymeric resin, wherein the textured layer has surface features defined by a varying depth;
digitally printing up to four independent color layers comprising a color layer polymeric resin and inorganic ink on the primer layer or textured layer and at least partially curing each printed color layer before printing the next color layer, the up to four color layers are selected from a cyan color layer, a magenta color layer, a yellow color layer, and a black color layer;
fully curing the up to four color layers; and
applying a protective layer polymeric resin to the up to four color layers and curing the protective layer polymeric resin to form the protective layer.

18. (canceled)

19. The method of claim 17, wherein
when the filler includes an organic filler, the filler comprises wood flour, wood fibers, sawdust, wood shavings, newsprint, paper, flax, hemp, wheat straw, rice hulls, kenaf, jute, sisal, seed shells, soy hulls, or combinations thereof, and
when the filler includes a mineral filler, the filler comprises talc, mica, clay, feldspar, diatomaceous earth, fumed silica, amorphous silica, fumed aluminum oxide, sand, wollastonite, calcium carbonate, carbon black, glass fibers, glass beads, or combinations thereof.

20. The method of claim 17, wherein the etching comprises at least one of the following surface treatments: mechanical etching, chemical etching, plasma etching, corona etching, flame etching, or combinations thereof.

21. The method of claim 20, wherein the etching increases the surface energy to greater than or equal to 45 mN/m for a period of time sufficient to apply and cure the opaque tie layer polymeric resin on the at least one etched surface.

22. (canceled)

23. The method of claim 17, wherein the opaque tie layer has an opacity value of 90-100%.

24. The method of claim 17, wherein the CIELAB Delta E of the exterior composite board is less than 5 units when tested over 10,000 hours under the QUV Weathering Test.

25. An exterior composite board, comprising:
a core comprising
a polymeric resin comprising a polyethylene (PE), polypropylene (PP), a polyethylene terephthalate (PET), a thermoplastic elastomer (TPE), or combinations thereof, and
a filler comprising an organic filler, a mineral filler, or combinations thereof,
the core having a top surface, a bottom surface opposing the top surface, a left side surface, and a right side surface opposing the left side surface, the left and right side surfaces each extend between the top surface and the bottom surface;
an opaque tie layer disposed on at least one surface of the core, the opaque tie layer comprising a cured polymeric resin;
a color layer disposed on the opaque tie layer, the color layer comprising a cured polymeric resin and an inorganic ink; and
a protective layer,
wherein the adhesive value between the tie layer and at least one surface of the core upon which the tie layer is disposed has less than about 5% of material removed according to the Cross-Cut Tie Layer Tape Test.
